(19) United States
(12) Patent Application Publication
(10) Pub. No.: US 2003/0007206 A1
(43) Pub. Date: Jan. 9, 2003

(54) Device and method for monitoring optical signals with increased dynamic range

(75) Inventors: Michael Sussman, Winchester, MA (US); David A. Coppeta, Atkinson, NH (US)

Correspondence Address: William F. Esser, Jenkens & Gilchrist, P.C., 3200 Fountain Place, 1445 Ross Avenue, Dallas, TX, 75202-2799, US

(73) Assignee: Lightchip, Inc.

(21) Appl. No.: 10/162,161

(22) Filed: Jun. 3, 2002

Related U.S. Application Data
(60) Provisional application No. 60/295,253, filed on Jun. 1, 2001.

(51) Int. Cl. H04B 10/08; H04J 14/02

(52) U.S. Cl. 359/110; 359/124

(57) ABSTRACT

An optical monitor device and method are disclosed for measuring characteristics of optical signals in an optical communications network. The optical monitor device may include an array of optical detector elements on which the optical signals, each having a different wavelength, may be substantially concurrently imaged, and a processing element. The array of optical detector elements may be controlled so that for each optical signal, a plurality of measurements may be obtained, with each measurement occurring at a distinct optical sensitivity level. The processing element may select, for each optical signal, the measurement providing the most accurate measurement of the optical signal. In this way, the dynamic range of the optical monitor device is increased relative to the dynamic range of the array of optical detector elements.

### BACKGROUND OF THE INVENTION

1. Technical Field of the Invention

The present invention relates to monitoring optical signals in an optical telecommunications network, and particularly to a device and method for monitoring optical signals with increased dynamic range.

2. Description of the Related Art

With the increasing demand for bandwidth driven by the Internet, as well as more traditional telecom services, global bandwidth is doubling approximately every 100 days. The ability of networks to handle this increase in demand is made possible by the industry shift to Dense Wavelength Division Multiplexing (DWDM).

Networks which support DWDM typically allocate a center wavelength for each channel that a fiber is to carry. Because each channel has its own distinct wavelength, the information carried by each fiber is increased by the number of wavelengths used. This provides a tremendous cost advantage and allows information-carrying capacity to grow without having to utilize an additional fiber for each channel. Increasingly, existing optical networks typically deploy optical performance monitors (OPMs) to measure critical parameters of the channels carried by a fiber, such as the power, center wavelength, and the optical signal to noise ratio (OSNR) associated with each channel. An OPM is essentially a spectrometer. The measurement of these parameters is ideally accurate over time, temperature, and other environmental factors in order for problems in the optical telecommunications network to be correctly identified. The measurement of parameters of channels carried by the fiber may also be used to enable applications such as laser locking and gain balancing.

Some conventional OPMs employ solid state focal plane arrays. The dynamic range of this class of OPM is typically limited by the detector array itself. Conventional detector arrays, such as those based upon InGaAs, have good responsivity in the optical C and L bands. The InGaAs detector arrays that are available as off-the-shelf components typically have dynamic ranges varying between 35 dB and 40 dB. Practically speaking, a 36 dB (12 bits) dynamic range is readily realizable.

The dynamic range of the detector array affects the ability of the OPM to accurately measure center wavelength, optical power, and OSNR. A detector array having a sensitivity level that is too low may result in unacceptable OSNRs for weaker signals when strong signals are adequately measured. Conversely, if the sensitivity level of the detector array is adjusted to adequately measure weak signals, strong signals may saturate the detector elements in the detector array. Existing techniques for addressing the limited dynamic range of detector arrays have led to unacceptably long acquisition times, which thereby substantially reduce a significant advantage detector arrays possess over scan-based spectrometers.

Adding further to the shortcoming of detector arrays having a limited dynamic range is the fact that the power levels between optical channels carried by a fiber may differ depending upon the modulation format employed. Optical channels may be added or dropped at various locations in an optical communications network, thereby causing power disparity between the optical channels carried by an optical fiber. Further, optical performance monitors should be capable of being placed anywhere in the optical communications network, thereby leading to greater uncertainty with respect to power levels of optical channels carried by the fiber.

Based upon the foregoing, there is a need for more accurate measurement of optical signal characteristics, such as signal power, despite utilization of existing detection devices.

### SUMMARY OF THE INVENTION

Embodiments of the present invention overcome shortcomings in existing OPMs and detector arrays therein, and satisfy a significant need for an OPM having an increased dynamic range relative to the dynamic range of the detector array utilized by the OPM. In an exemplary embodiment of the present invention, the OPM includes a spectrometer having an optical layer and an array of optical detector elements. The optical layer spatially disperses the wavelength division multiplexed optical signal received by the OPM, and images the optical signals onto the detector array of optical detector elements.

The detector array performs a plurality of signal measurements on the optical signals imaged thereon, with each signal measurement occurring with the detector array set at a distinct optical sensitivity level.

A processing element is coupled to the spectrometer to selectively vary the optical sensitivity level of the detector array during the time the optical signals are measured. The processing element may receive the signal measurements generated by the detector array at the various optical sensitivity levels and provide a single measurement of each optical signal. For each optical detector element in the detector array, the processing element selects the signal measurement for which the detector element most accurately measures the optical signal imaged thereon. The processing element then compiles the selected measurement for each detector element and/or optical signal to obtain a selected set of measurements of the optical signals. By selecting a signal measurement for each optical detector element/optical signal from a series of measurements at various sensitivity levels of the detector array, the dynamic range of the detector array is effectively increased.

### BRIEF DESCRIPTION OF THE DRAWINGS

A more complete understanding of the system and method of the present invention may be obtained by reference to the following Detailed Description when taken in conjunction with the accompanying Drawings wherein:

FIG. 1 is a block diagram of an OPM according to an exemplary embodiment of the present invention;

FIG. 2 illustrates the dynamic range for various sensitivity levels for the detector array shown in the OPM of FIG. 1;

FIG. 3A is a timing diagram illustrating varying integration times for measuring optical signals by the OPM of FIG. 1 according to an exemplary embodiment of the present invention;

FIG. 3B is a block diagram of a portion of a detector array of the OPM of FIG. 1 according to an exemplary embodiment of the present invention;

FIG. 4 illustrates a condition resulting in the occurrence of a worst case SNR of a signal measurement; and

FIGS. 5 and 6 are flow charts illustrating an operation of the OPM of FIG. 1 according to an exemplary embodiment of the present invention.

### DETAILED DESCRIPTION OF THE EXEMPLARY EMBODIMENTS

The present invention will now be described more fully hereinafter with reference to the accompanying drawings in which exemplary embodiments of the invention are shown. This invention may, however, be embodied in many different forms and should not be construed as being limited to the embodiments set forth herein. Rather, the embodiments are provided so that this disclosure will be thorough and complete, and will fully convey the scope of the invention to those skilled in the art.

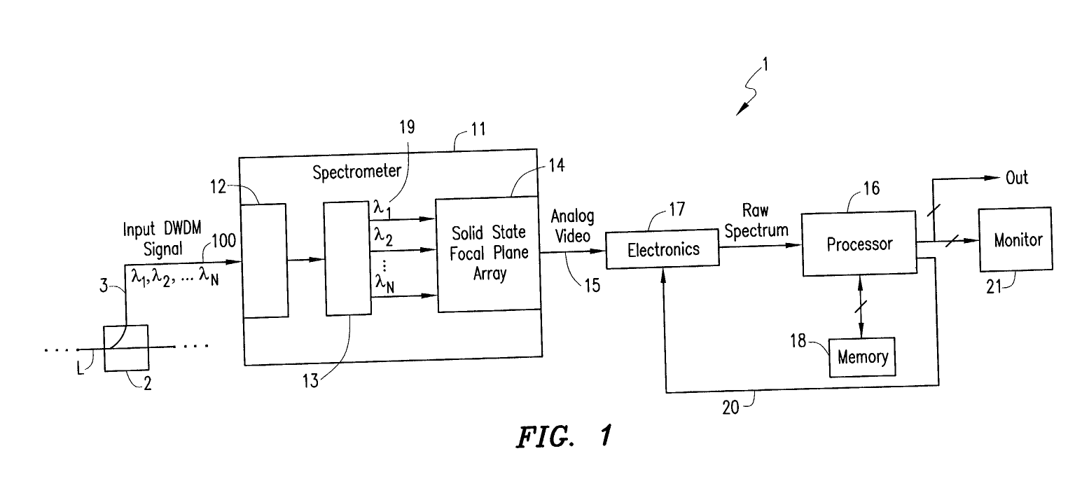

Referring to FIG. 1, there is shown an optical performance monitor (OPM) 1 according to an exemplary embodiment of the present invention. OPM 1 is adapted to be coupled to a fiber optic line L so as to monitor optical signals transported thereon. For example, an optical tap or splitter 2 may be coupled to fiber optic line L so as to tap onto fiber optic line 3 a relatively small portion of optical signals transported on fiber optic line L. OPM 1 may receive at its input a wavelength division multiplexed optical signal 100 tapped by optical tap 2.

OPM 1 is capable of measuring one or more signal characteristics, such as power, center wavelength and optical signal to noise ratio (OSNR), of wavelength division multiplexed optical signals received by OPM 1. In this way, OPM 1 is utilized to monitor the operation or state of an optical communications network. OPM 1 may include a spectrometer 11 having optic components 12, such as one or more lenses, and a dispersion engine 13 for spatially dispersing the wavelength division multiplexed optical input signal 100 so that the optical power spectrum 19 is imaged onto an array 14 of optical detector elements. Detector array 14 is adapted to convert, in parallel, the optical power spectrum 19 into electrical signals appearing on at least one or more signal lines 15. Detector array 14 may, for example, be an indium gallium arsenide optical detector. The electrical signals may be analog signals having a current or voltage level representing a power level of the optical power spectrum 19 imaged onto detector array 14.

Spectrometer 11 may further include various electronics 17 for suitably conditioning the electrical signals generated by detector array 14. Electronics 17 may include, for example, amplifier circuitry and analog-to-digital converter (ADC) circuitry. The general implementation and operation of optic components 12, dispersion engine 13 and electronics 17 are known and will not be described in greater detail for reasons of simplicity.

A processing unit 16 may receive signals generated by electronics 17 and perform various signal processing operations thereon, dependent upon the particular signal characteristics desired. Processing unit 16 may include a general purpose processor operating on software code stored in memory 18 or a digital signal processor (DSP). OPM 1, and particularly processing unit 16, may generate a control signal on a control line 20 that controls or selectively varies the optical sensitivity level of detector array 14. Based upon the software code, processing unit 16 may also provide to a monitor 21 or other device in the optical communication network with signal(s) indicative of at least one signal characteristic of the wavelength division multiplexed signal 100, such as channel power, center wavelength and OSNR.

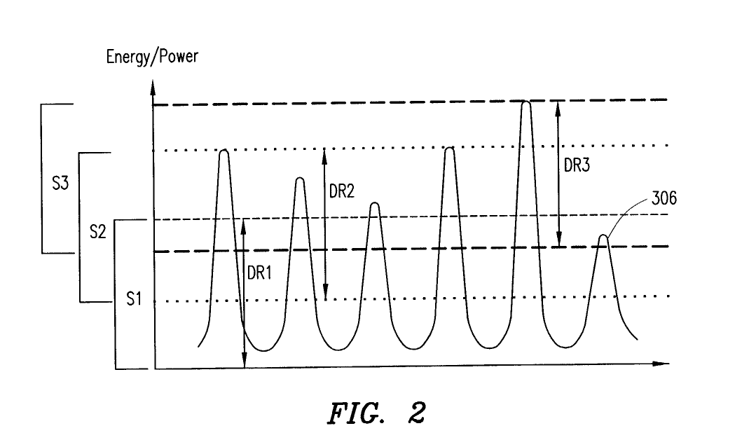

As discussed above, commercially available detector arrays have a dynamic range that is typically limited to 40 dB or less. Because an optical power spectrum incident on a detector array may vary considerably beyond a 40 dB range, the dynamic range of the commercially available detector arrays is not well suited to accurately measure all relevant power levels of an optical power spectrum 19. Consider, for example, the signal measurement capability of detector array 14 at three distinct sensitivity levels. FIG. 2 shows three distinct dynamic ranges DR1-DR3 corresponding to signal measurements with detector array 14 configured at optical sensitivity levels S1-S3, respectively. With the highest sensitivity level S1, detector array 14 samples the valleys between the spectra and the weakest signal peak, and all other signal peaks saturate.

At the intermediate sensitivity level S2, detector array 14 is capable of accurately sampling signals at intermediate power levels. The detector elements of detector array 14 saturate when measuring the optical power spectrum 19 at the highest power levels. In addition, the detector elements of detector array 14 do not measure relatively low power signals as well as when detector array 14 performs signal measurements at sensitivity level S1. It is noted that for measurements at sensitivity level S2, the dynamic range of detector array 14 has been upwardly shifted from the dynamic range of detector array 14 at sensitivity level S1, by an amount equaling the ratio of S1/S2.

At a low sensitivity level S3, detector array 14 is capable of accurately measuring signal levels at the strongest peaks without saturation, but is incapable of accurately measuring lower power signals.

As can be seen, the limited dynamic range of commercially available detector arrays may render accurate measurement of an optical power spectrum difficult. A more satisfactory coverage of a power spectrum occurs when detector array 14 measures an optical power spectrum 19 at multiple sensitivity levels.

In accordance with an exemplary embodiment of the present invention, OPM 1 combines or stitches signal measurements at multiple sensitivity levels, such as at sensitivity levels S1-S3, and thereby improves or widens the effective dynamic range of OPM 1, relative to the dynamic range of detector array 14 itself. During signal measurement, processing unit 16 controls and selectively varies the sensitivity level of detector array 14.

It is understood that the number of sensitivity levels utilized to measure the optical power spectrum 19 incident on detector array 14 may vary. A tradeoff between speed (i.e., using fewer sensitivity levels) versus accuracy (i.e., using a greater number of sensitivity levels) may be considered in determining the number of sensitivity levels at which measurements of optical power spectrum 19 are obtained.

In order to combine optical signal measurements at different sensitivity levels so as to result in an effective, single dynamic range, the sensitivity levels need to be maintained with relatively high accuracy. In an ideal case, the sensitivity levels may be more tightly controlled than the control of the dynamic range of the detector elements themselves. Varying the sensitivity level of detector array 14 may be accomplished in any of a number of ways.

One way in which the sensitivity level of detector array 14 may be varied, assuming each detector element has its own CTIA (capacitance transimpedance amplifier) or charge well, is by varying the integration time over which detector array 14 measures optical power spectrum 19. The integration time over which the detector elements of detector array 14 integrates and/or accumulates charge is linearly proportional to the sensitivity of detector array 14. In this case, integration time for signal measurements by detector array 14 may be controlled by processing unit 16 generating a control signal on signal line 20. It is understood that a device other than processing unit 16 may provide a control signal to detector array 14, such as a crystal oscillator circuit.

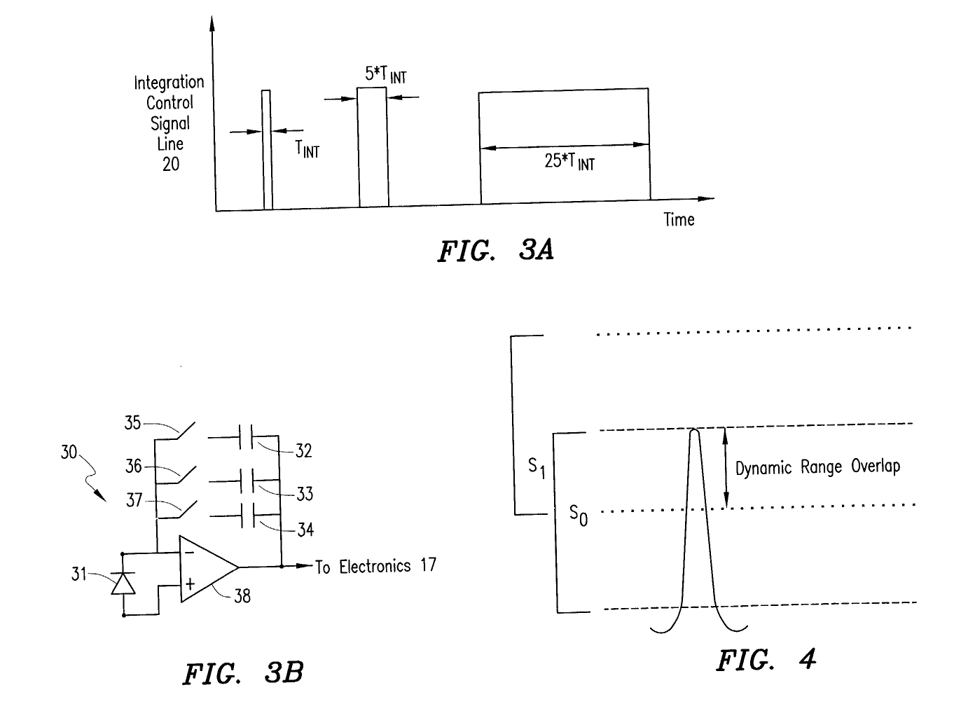

FIG. 3A illustrates how the integration time may be varied. Signal measurements may be performed by detector array 14 at a small integration time TINT so as to provide a low sensitivity level; an intermediate integration time that is, for example, five times the small integration time, so as to provide an intermediate sensitivity level; and a relatively long integration time, such as five times the intermediate integration time, so as to provide the highest sensitivity level. These three sensitivity levels, each of which is increased by a factor of five relative to the next lower sensitivity level, may be stitched to form a single measurement, by selecting the appropriate sensitivity for each detector element and scaling the result accordingly, as described below. In this way, the effective dynamic range is increased by a factor of 25 (13.97 dB).

It is understood that the order of sensitivity levels used in measuring the optical power spectrum 19, the number of distinct integration times utilized, and the scale factors between integration times may be varied as desired.

A second way in which the sensitivity level of detector array 14 may be varied is by varying the amplification of the signals measured thereby. In particular, each detector element of detector array 14 may include a transimpedance amplifier 30 (FIG. 3B) that integrates, with varied sensitivity, the photo-current level of the corresponding detector element. FIG. 3B shows a detector element 31 (represented as a photodiode) coupled to its corresponding transimpedance amplifier 30. It is understood that each detector element in detector array 14 may be associated with a distinct transimpedance amplifier 30. Each transimpedance amplifier 30 may be an operational amplifier 38 configured as an integrator, with a capacitance connected in the feedback path. In this case, a number of capacitors 32-34 may be connected in parallel relation in the feedback path of a transimpedance amplifier 30, with each capacitor 32-34 having a distinct capacitance value and being connected in series with a switch 35-37. A first capacitor 32, for example, may have five times the capacitance of a second capacitor 33, which itself may have five times the capacitance of a third capacitor 34. The open/closed state of switches 35-37 may be controlled by processing unit 16. By selectively activating the switches 35-37, the feedback capacitance of the corresponding transimpedance amplifier 30 is varied, which thereby changes the sensitivity of transimpedance amplifier 30. By varying the feedback capacitance of transimpedance amplifiers 30 in detector array 14, the sensitivity of detector array 14 is selectively varied.

A third way in which the sensitivity level of detector array 14 may be varied is by varying both the integration time of detector array 14 as well as the gain of transimpedance amplifiers 30.

It is understood that the number of sensitivity levels used and the differences in sensitivity levels relative to each other may vary depending upon a number of factors, including a tradeoff between speed and accuracy. For example, if detector array 14 has an inherent dynamic range of 36 dB and it is desired to achieve a dynamic range for detector array 14 of 60 dB, the highest and lowest sensitivity measurements must vary by 24 dB, or eight bits. Since 24 dB is less than the dynamic range of detector array 14, as few as two sets of signal measurements (at two distinct sensitivity levels) could be used.

Further, it is understood that measurement accuracy increases with an increase in overlap of dynamic range between different sensitivity levels. The worst case SNR of a measurement may be estimated for a given overlap of dynamic ranges. With reference to FIG. 4, the worst case SNR may be seen to occur when the optical signal 19 incident on a detector element begins to saturate the detector element for a first sensitivity level S₀. The measurement of the optical power spectrum 19 at the next lower sensitivity level S₁ (i.e., a second sensitivity level) will have an SNR of no more than the overlap between the two dynamic ranges corresponding to the first and second sensitivity levels. The noise level at sensitivity S₁ is below the peak signal by the overlap with the saturated scan S₀. The overlap is the dynamic range of detector array 14 (in dB) less the ratio between the acquisitions (in dB).

A phenomenon occurs in conventional detector arrays, and particularly in P-I-N diode InGaAs detector arrays, which adversely affects the ability to accurately measure optical power spectrum 19. When a detector element in a detector array 14 saturates, the photodiode forming the detector element may become forward biased and inject excess current into neighboring detector elements. The injected excess current may become significant and may adversely affect accurate optical signal measurement by the detector elements. The existence of excess charge injection may be identified by examining the incident optical signal measured at different sensitivity levels of the detector element. It is noted that local charge injection changes substantially linearly with optical signal power above optical power levels necessary to saturate the detector element at a particular sensitivity, and excess charge injection does not scale linearly with detector sensitivity. These characteristics allow for excess charge injection to be observed by merely examining the optical signal 19 measured by the detector element at different sensitivity levels. The detection of excess charge injection will be described in greater detail below.

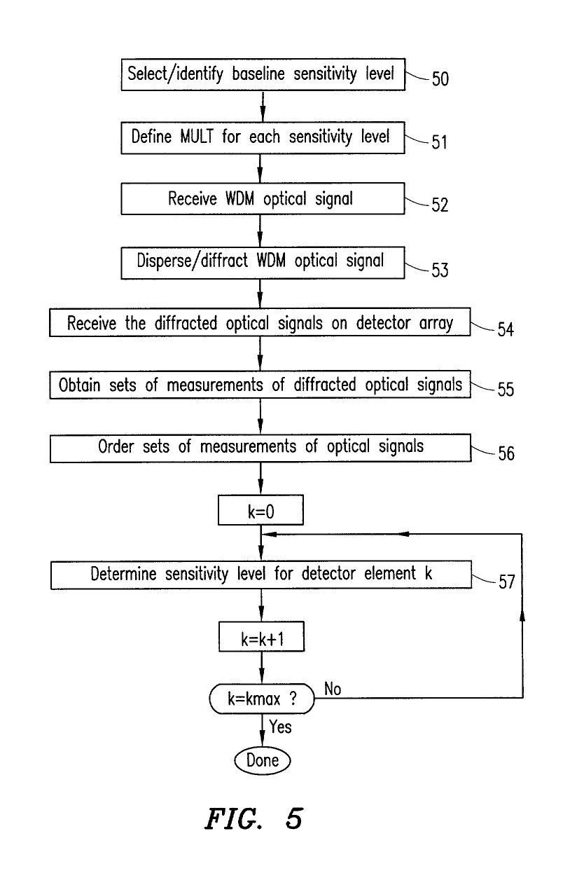

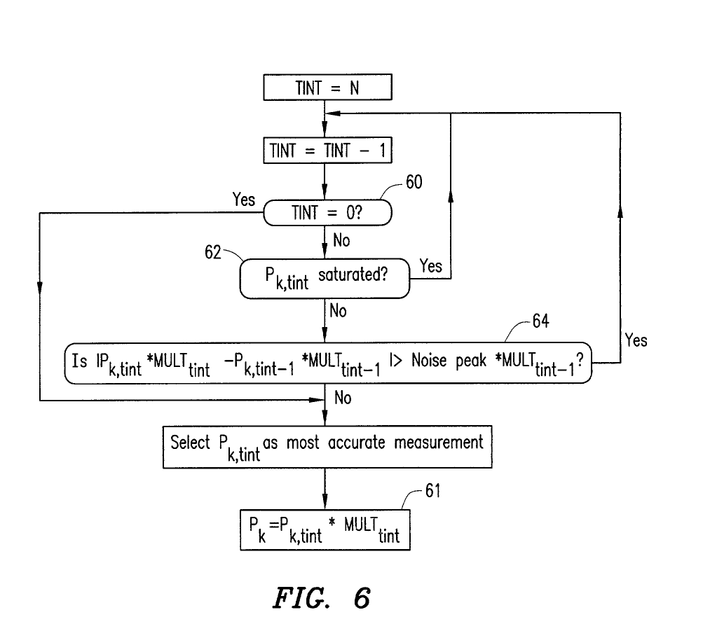

A method of measuring optical power spectrum 19 incident on detector elements of detector array 14 of OPM 1 will be described with reference to FIGS. 5 and 6. Initially, a baseline sensitivity level is selected at 50. For exemplary reasons only, the sensitivity level corresponding to the highest sensitivity level of detector array 14 is selected as the baseline sensitivity level. The N factors MULT_{N} are defined at 51 as a ratio of the sensitivity level of the baseline sensitivity level to each of the N sensitivity levels utilized in measuring the optical power spectrum 19.

Next, a wavelength division multiplexed optical signal 100 may be received at the input of OPM 1 at 52. The received wavelength division multiplexed optical signal 100 may be diffracted/dispersed by OPM 1 at 53 so that optical power spectrum 19 is incident on detector array 14. Sets of measurements of optical power spectrum 19 may be obtained by detector array 14 at 55, with each set of measurements having a distinct sensitivity level. This may be performed by scanning the detector array 14 a number of times, with detector array 14 being configured with a distinct sensitivity level for each scan operation. The sensitivity level of detector array 14 may be varied by altering the integration time for each scan operation, altering the gain of transimpedance amplifiers 30 of detector array 14, a combination thereof, or employing other techniques. Next, the sets of measurements may be ordered by processing unit 16 at 56 corresponding to the lowest sensitivity level to the highest sensitivity level. Processing unit 16 may then determine at 57, for each detector element of detector array 14, the sensitivity level of detector array 14 providing the most accurate measurement of the optical signal that is incident on the detector element. This determination may be performed sequentially for each detector element, as indicated in FIG. 6. By employing the most accurate measurements for each detector element in detector array 14 when analyzing the signal characteristics of the wavelength division multiplexed optical signal 100 received by OPM 1, the effective dynamic range of detector array 14 is increased.

FIG. 6 illustrates the step of determining, for any detector element k, the sensitivity level of detector array 14 providing the most accurate measurement of the optical signal incident on the detector element k. Initially, an index variable TINT is set to an index value corresponding to the highest sensitivity level being considered. In this case, the number zero corresponds to the lowest sensitivity level and the number N-1 corresponds to the highest sensitivity level at which a signal measurements are taken. At this point, the highest sensitivity level is considered (i.e., TINT=N−1). A determination is performed at 60 whether the sensitivity level being considered is the lowest sensitivity level. If so, the signal value Pₖ obtained by the particular detector element k to be utilized by processing unit 16 is determined at 61 to be the measured signal at the lowest sensitivity level multiplied and/or scaled by factor MULT₀ (i.e., the factor MULT for the lowest sensitivity level).

Otherwise, a determination is made at 62 whether the optical signal measured by the particular detector element k is saturated. In the event that step 62 is determined in the affirmative, index variable TINT is decremented at 63 to point to the next lower sensitivity level to be considered. In the event the signal measured by the detector element k is not saturated, a determination is then made at 64 whether excess charge was injected from neighboring detector elements. The determination at step 64 is performed by comparing the signal measured by detector element k at the sensitivity level considered and suitably scaled to the baseline sensitivity level (i.e., the product of P_{K,TINT} and MULT_{TINT}), to the signal measured by detector element k at the next lower sensitivity level and also suitably scaled to the baseline sensitivity level (i.e., the product of P_{K,TINT-1} and MULT_{TINT-1}). It is noted that the scaled signal measured by the detector element k at the sensitivity level considered, P_{K,TINT}*MULT_{TINT}, would be equivalent to the measured signal at the highest sensitivity level if saturation did not occur. Similarly, the scaled signal measured by the detector element k at the next lower sensitivity level, P_{K,TINT-1}*MULT_{TINT-1}, would be equivalent to the measured signal at the highest sensitivity level if saturation did not occur.

In particular, the absolute value of the difference between P_{K,INT}*MULT_{TINT} and P_{K,TINT-1}*MULT_{TINT-1} is compared to the peak noise value of the detector element k over temperature, Noiseₚₑₐₖ, that is suitably scaled to the baseline sensitivity level (i.e., the product of Noiseₚₑₐₖ and MULT_{TINT-1}). It is noted that the noise parameter Noiseₚₑₐₖ is a threshold value which is exceeded in the presence of excess carrier injection. If the absolute value of the difference is greater than the scaled noise parameter, excess carrier injection occurred and the index variable TINT is decremented so that the signal measurement corresponding to the next lower sensitivity level is considered. Alternatively, if the absolute value of the difference is less than the scaled noise parameter, then substantially no excess carrier injection is seen to have occurred, and the measurement Pₖ corresponding to detector element k is the product P_{K,TINT}*MULT_{TINT}. This measurement may be utilized thereafter for analyzing the characteristics of the wavelength division multiplexed optical signal 100 received at the input of OPM 1.

It is understood that instead of determining the sensitivity level providing the most accurate signal measurement for each detector element in detector array 14, the sensitivity level providing the most accurate signal measurement may be determined for less than all of the detector elements in detector array 14. For instance, in the event some detector elements of detector array 14 are unused or otherwise incapable of having an optical signal imaged thereon, the determination by processing unit 16 of the optimal sensitivity level of that unused detector element may go unperformed.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of monitoring optical signals transported over a fiber optic line, comprising:
receiving a wavelength division multiplexed optical signal including a plurality of optical signals centered at different wavelengths within a range of wavelengths;
spatially dispersing the optical signals of the multiplexed optical signal;
imaging the dispersed optical signals on an array of detector elements;
for each detector element on which an optical signal is imaged, measuring a plurality of times an optical power level of the optical signal imaged on the detector element, each measurement occurring at a different sensitivity level;
for each detector element on which an optical signal is imaged, selecting a measurement from the plurality of measurements for which the detector element most accurately measures the optical power level of the optical signal imaged thereon; and
compiling the selected measurements to obtain a single set of measurements of the optical power level of the optical signals.

2. The method of claim 1, wherein the step of measuring comprises:
setting a predetermined optical sensitivity level of the array of detector elements;
measuring, by each detector element in the array of detector elements, the optical signal imaged thereon to obtain a set of measurements of the optical signal; and
repeating the steps of setting and measuring at least one time, wherein each step of setting sets the optical sensitivity level of the array of detector elements to a distinct predetermined optical sensitivity level.

3. The method of claim 2, wherein the step of setting a predetermined optical sensitivity level comprises:
setting the integration time for optical measurements by the array of detector elements to a distinct time period.

4. The method of claim 3, wherein the step of setting a predetermined optical sensitivity level further comprises:
setting an amplification level of signals measured by the array of detector elements.

5. The method of claim 2, wherein:
the step of setting a predetermined optical sensitivity level further comprises setting an amplification level of signals measured by the array of detector elements; and
the step of measuring comprises measuring, at each detector element, an electrical parameter generated by the optical signal imaged onto the detector element during a predetermined period of time, and amplifying the measured electrical parameter by the amplification level.

6. The method of claim 1, further comprising:
for each detector element on which an optical signal is imaged, determining whether the detector element was saturated during one or more of the measurements, wherein the step of selecting comprises selecting, for each detector element on which an optical signal is imaged, a measurement based upon the step of determining.

7. The method of claim 1, further comprising:
for each for each detector element on which an optical signal is imaged, determining whether the detector element was subjected to injected excess charge from one or more neighboring detector elements during one or more of the measurements, wherein the step of selecting comprises selecting, for each detector element on which an optical signal is imaged, a measurement based upon the step of determining.

8. The method of claim 1, wherein the step of selecting further comprises:
for each detector element on which an optical signal is imaged, comparing a value corresponding to a first measurement at a first sensitivity level with a value corresponding to a second measurement at a second sensitivity level lower than the first sensitivity level, the selected measurement being based upon the comparison.

9. The method claim 8, wherein:
the value corresponding to the first measurement comprises a product of a first predetermined multiplier and the first measurement; and
the value corresponding to the second measurement comprises a product of a second predetermined multiplier and the second measurement, the first and second multipliers serving to scale the first and second measurements, respectively, to measurements at a predetermined baseline sensitivity level.

10. The method of claim 9, wherein if the comparison shows a difference between the value corresponding the first measurement and the value corresponding to the second measurement being greater than a predetermined amount, the first measurement is not selected during the step of selecting.

11. The method of claim 10, wherein the predetermined amount is based upon a predetermined peak noise value of the measurements over a temperature range.

12. The method of claim 8, wherein the step of selecting further comprises:
for each detector element on which an optical signal is imaged, comparing a value corresponding to a third measurement at a third sensitivity level lower than the second sensitivity level, upon a determination that the comparison of the value corresponding to the first measurement and the value corresponding to the second measurement yielded a difference having a magnitude exceeding a predetermined noise level.

13. A device for monitoring optical signals, comprising:
a spectrometer comprising an optical layer and an array of optical detector elements, the optical layer being in optical communication with the array of optical detector elements so as to image an optical power spectrum corresponding to a wavelength division multiplexed optical signal received by the spectrometer onto the array of optical detector elements; and
a processing element coupled to the spectrometer to receive signals generated thereby and to provide a set of measurements of the optical power spectrum, the processing element being adapted to selectively vary an optical sensitivity level of the array of optical detector elements during measurement of the optical power spectrum so as to increase the dynamic range of the device.

14. The device of claim 13, wherein:
the processing element receives a plurality of sets of measurements of the optical power spectrum from the array of optical detectors, each set of measurements being at a distinct optical sensitivity level, and for each optical signal imaged onto a detector element, the processing element selects a single measurement for which the corresponding detector element most accurately measures the optical signal.

15. The device of claim 14, wherein:
for each optical signal imaged on a detector element, the processing element selects an unsaturated measurement thereof as the most accurate measurement.

16. The device of claim 14, wherein:
for each optical signal imaged on a detector element, the processing element selects a measurement thereof that does not include an appreciable amount of charge injected from a t least one neighboring detector element into the detector element on which the optical signal is imaged.

17. The device of claim 14, wherein:
for an optical signal imaged on a detector element, the processing element selects a measurement for the optical signal that does not include excess charges injected by at least one neighboring detector element into the detector element on which the optical signal is imaged.

18. The device of claim 14, wherein:
the processing element compares, for each optical signal imaged on a detector element, a first value corresponding to a first measurement at a first optical sensitivity level with a second value corresponding to a second measurement at a second optical sensitivity level less than the first optical sensitivity level, the selected measurement of the optical signal being based upon the comparison.

19. The device of claim 18, wherein:
the first and second measurements are measurements of the optical signal that do not saturate the corresponding optical detector element.

20. The device of claim 18, wherein:
the first value comprises the product of the first measurement of the optical signal by the detector element and a first multiplication value; and
the second value comprises the product of the second measurement of the optical signal by the detector element and a second multiplication value, the first and second multiplication values being values to scale the first and second measurements to a baseline sensitivity level.

21. The device of claim 18, wherein:
in the event the difference between the first value and the second value is greater than a predetermined noise level, the processing element determines that the first measurement of the corresponding optical detector element included an appreciable amount of charge injection by at least one neighboring optical detector element and the first measurement is not selected as the single measurement that most accurately measures the optical signal imaged on the detector element.

22. The device of claim 21, wherein:
the predetermined noise level comprises a product of a maximum allowable noise level and the second multiplication value.

23. The device of claim 18, wherein:
in the event the difference between the first value and the second value is less than a predetermined noise level, the processing element determines that the first measurement of the detector element does not include an appreciable amount of charge injection from at least one neighboring optical detector elements.

24. The device of claim 23, wherein:
the predetermined noise level comprises a product of a maximum allowable noise level and the second multiplication value.

25. The device of claim 13, wherein:
the dynamic range of the array of optical detector elements is at least 55 db.

26. A computer program product for an optical signal monitor device including an array of detector elements, including instructions stored on a computer medium which, when executed by a processor of the optical signal monitor device, operate to:
obtain, from the array of detector elements, a plurality of sets of measurements of optical signals imaged on the detector elements, each set of measurements having a distinct optical sensitivity level;
for each optical signal imaged on the array of detector elements, select a measurement from the plurality of measurements for which most accurately measures the optical signal; and
compile the selected measurements of each optical signal to obtain a single set of measurements of the optical signals.

27. The computer program product of claim 26, wherein the instructions to obtain include instructions for causing the processor and the array of detector elements to:
set a predetermined optical sensitivity level of the array of detector elements for measuring the optical signals;
measure, by each detector element in the array of detector elements, the optical signal imaged thereon to obtain a set of measurements of the optical signal; and
repeat the sequence of setting and measuring at least one time, wherein for each sequence the processor sets the optical sensitivity of the array of the detector elements to a distinct predetermined optical sensitivity level.

28. The computer program product of claim 27, wherein the instructions for setting a predetermined optical sensitivity level causes the processor to:
set the integration time for signal measurements by the array of detector elements to a distinct time period.

29. The computer program product of claim 28, wherein the instructions for setting a predetermined optical sensitivity level further causes the processor to:
set an amplification level of signals measured by the array of detector elements.

30. The computer program product of claim 27, wherein the instructions for setting a predetermined optical sensitivity level further causes the processor to:
set an amplification level of signals measured by the array of detector elements.

31. The computer program product of claim 26, wherein the instructions for selecting comprises instructions for:
selecting a measurement for each optical signal imaged on the array of detector elements in which the corresponding detector element is not saturated.

32. The computer program product of claim 26, wherein the instructions for selecting comprises instructions for:
selecting a measurement for each optical signal in which the corresponding detector element does not receive an appreciable charge injected by one or more neighboring detector elements.

33. The computer program product of claim 26, wherein the instructions for selecting further include instructions that cause the processor to:
for each optical signal, compare a value corresponding to a first measurement thereof with a value corresponding to a second measurement of the optical signal, the second measurement having a next lower optical sensitivity level relative to the first measurement, the selected measurement of the optical signal being based upon the comparison.

34. The computer program product of claim 33, wherein:
the value corresponding to the first measurement comprises a product of a first predetermined multiplier and the first measurement of the optical signal; and
the value corresponding to the second measurement of the optical signal comprises a product of a second predetermined multiplier and the second measurement of the optical signal.

35. A monitor device, comprising:
one or more optical detector elements for receiving one or more optical signals and providing a plurality of sets of measurements of the one or more optical signals, each set of measurements being at a distinct optical sensitivity level; and
processing means for receiving the sets of measurements and selecting a measurement of each of the one or more optical signals therefrom, wherein for each of the one or more optical signals, the selected measurement is the most accurate measurement thereof.

36. The monitor device of claim 35, wherein:
for each of the one or more optical signals, the processing means selects the measurement thereof having the highest optical sensitivity level without saturating the corresponding optical detector element and without receiving an appreciable amount of carriers injected by one or more neighboring optical detector elements of the corresponding optical detector element.

37. The monitor device of claim 35, wherein:
for each set of measurements of the one or more optical signals, the one or more optical detector elements have a distinct integration time.

38. The monitor device of claim 35, wherein:
each of the one or more detector elements includes an amplifier circuit; and
for each set of measurements of the optical signal, the amplifier circuits have a distinct gain factor.
